(19) United States
(12) Patent Application Publication
(10) Pub. No.: US 2008/0222934 A1
(43) Pub. Date: Sep. 18, 2008

(54) Label Holder

(76) Inventor: Jeff Dworetz, Atlanta, GA (US)

Correspondence Address: MYERS & KAPLAN;INTELLECTUAL PROPERTY LAW, L.L.C., CUMBERLAND CENTER II, 3100 CUMBERLAND BLVD , SUITE 1400, ATLANTA, GA, 30339, US

(21) Appl. No.: 12/049,555

(22) Filed: Mar. 17, 2008

Related U.S. Application Data
(60) Provisional application No. 60/895,040, filed on Mar. 15, 2007.

(51) Int. Cl. G09F 3/18

(52) U.S. Cl. 40/661; 40/642.02; 40/661.01

(57) ABSTRACT

A device, and method of manufacture therefor, for removable attachment of cards or labels to a structure, such as a file cabinet, that allows for improved ease of use, especially during removal of a card or label from the device for alteration or replacement, comprising a magnetic sheet and at least one transparent sheet attached to a front surface thereof to form a pocket between the magnetic sheet and the transparent sheet for receiving the label or card.

### RELATED APPLICATION

The present United States non-provisional utility patent application is related to, and hereby claims priority to and the full benefit of, United States provisional patent application entitled “Label Holder”, having assigned Ser. No. 60/895,040, and filed Mar. 15, 2007 on behalf of Jeff Dworetz.

### TECHNICAL FIELD

The present invention relates generally to signage, and more particularly to holders for documents, such as cards or labels.

### BACKGROUND OF THE INVENTION

In numerous varied applications, it is desirable to provide a sign, label, or other indication at a conspicuous location, such as on the exterior of a closed container. To this end, numerous labels and labeling techniques have been employed in order to provide an indication pertaining to such a container or other structure.

An illustrative example is a card retaining device permanently attached to the structure, such as a file cabinet, for removably receiving a card bearing an indication, such as an indication pertaining to the contents, ownership, or responsibility of the cabinet, or a particular drawer thereof. Such permanent structures have proven inconvenient due to the inability to change the location of the label, or to easily include additional labels. Furthermore, such permanent structures are not easily replaced should they become damaged, soiled, or otherwise need to be replaced.

In order to overcome the disadvantages associated with such permanent card retaining structures, adhesive labels have been used in place of, or in conjunction with, such permanent structures. Adhesive labels have the advantage of being placed in a desired location about the exterior surface of the structure, as well as offering the ability to add supplemental labels should the need arise. Such adhesive labels, however, suffer the distinct disadvantage of being difficult or impossible to change or remove. If removed, the adhesive backing frequently soils the surface of the structure to which it was attached, leaving behind a sticky residue or unsightly paper remnants. Alternatively, a new label may be placed over the old, however this too has the unwanted appearance of sloppiness when the labels are not perfectly aligned, and repeated application of labels in this way leads to a large accumulation of labels.

Removable card or label holders, such as magnetic holders, have been employed to overcome these disadvantages, and to allow for easy removal, addition, or modification to label(s) attached to a structure, such as a file cabinet. Such magnetic label holders, however, suffer from an inability to easily remove and replace a card or label retained within the holder due to their design. Additionally, such magnetic label holders cannot be made in all sizes due to the inability to insert the label when certain dimensions of the holder are reduced beyond a threshold value.

It is clear, therefore, that what is needed is a card or label holder that allows for convenient placement, movement, and replacement of labels on a surface of a structure that allows for easy insertion and removal of a card or label from the holder, and that enables the holder to be formed in a greater range of sizes.

### BRIEF SUMMARY OF THE INVENTION

Briefly described, in a preferred embodiment, the present invention overcomes the above-mentioned disadvantages and meets the recognized need for such a device by providing a label holder for securing a card or label to a structure that is removably attachable to the structure and that includes means for removably receiving a card or label.

According to its major aspects and broadly stated, the present invention in its preferred form includes a magnetic sheet and a transparent sheet attached thereto, including a mouth allowing easy insertion and removal of a card or label. The mouth is preferably provided along a peripheral portion of the magnetic sheet, and is preferably formed to receive a width dimension of the card or label. Additionally, the mouth preferably comprises a cutout section configured to expose at least a portion of a front surface of the card or label proximate a peripheral edge thereof.

According to one aspect of the preferred embodiment, the magnetic sheet and the transparent sheet are flexible.

According to another aspect of the preferred embodiment, the magnetic sheet, the transparent sheet, and the card or label each comprises a rectangular shape, including a width and a height dimension.

According to another aspect of the preferred embodiment, the transparent sheet is attached to the magnetic sheet over substantially all of the peripheral edges thereof proximate a left side, a right side, and a bottom side.

According to another aspect of the preferred embodiment, the transparent sheet is attached to the magnetic sheet so as to form a substantially U-shaped pocket, with one substantially open edge, by which access to an interior of the pocket is enabled.

According to another aspect of the preferred embodiment, the width dimension is greater than the respective height dimension of each of the magnetic sheet, the transparent sheet, and the card or label.

According to another aspect of the preferred embodiment, the transparent sheet has substantially the same width and height as the magnetic sheet.

According to another aspect of the preferred embodiment, the card or label has substantially the same width and height as the pocket.

According to another aspect of the preferred embodiment, the holder comprises two or more transparent sheets attached to the magnetic sheet.

According to another aspect of the preferred embodiment, the relative magnitudes of the width and the height of the card or label and the pocket reduces an amount of friction therebetween, and accordingly reduces an insertion or removal force required to slide the card or label into or out of the pocket.

The present invention further overcomes the above-mentioned disadvantages and meets the recognized need for such a device by providing a method of manufacturing a removable label holder comprising the steps of determining a desired width of a pocket of the holder to receive a card or label, determining a maximum height dimension of the pocket that will allow for easy insertion and removal of the card or label, selecting a height less than or equal to the maximum height, and forming a holder having pocket with a width substantially equal to the determined width, and a height substantially equal to the selected height.

According to one aspect of the preferred method, the forming step comprises the step of attaching a transparent sheet to a magnetic sheet over substantially all of each of a left edge, a right edge, and a bottom edge, to form a substantially U-shaped pocket having a mouth along a top edge.

According to another aspect of the preferred embodiment, the forming step further comprises forming a cutout section along a portion of a peripheral edge of the mouth for exposing at least a portion of a front surface of the card or label when the card or label is disposed within the pocket.

Accordingly, a feature and advantage of the present invention is its ability to provide a card or label holder that can easily be attached to, moved about, and removed from a structure.

Another feature and advantage of the present invention is its ability to provide a pocket having a mouth that allows for easy insertion and removal of the card or label.

Another feature and advantage of the present invention is its ability to allow for easy removal of the card or label from the pocket by applying a removal force to a front surface of the card or label, the front surface being accessible via the cutout section.

Another feature and advantage of the present invention is its ability to allow for manufacture of a label holder having a smaller height dimension than previously possible by eliminating or reducing the tendency of a label to bind, bend, or stick during insertion.

These and other features and advantages of the invention will become more apparent to those ordinarily skilled in the art after reading the following Detailed Description of the Invention and Claims in light of the accompanying drawing Figures.

### BRIEF DESCRIPTION OF THE DRAWINGS

Accordingly, the present invention will be understood best through consideration of, and reference to, the following Figures, viewed in conjunction with the Detailed Description of the Invention referring thereto, in which like reference numbers throughout the various Figures designate like structure and in which:

FIG. 1 is a front perspective view of the label holder of the present invention according to the preferred embodiment; and

FIG. 2 is a front perspective view of an alternate embodiment of the present invention.

It is to be noted that the drawings presented are intended solely for the purpose of illustration and that they are, therefore, neither desired nor intended to limit the invention to any or all of the exact details of construction shown, except insofar as they may be deemed essential to the claimed invention.

### DETAILED DESCRIPTION OF THE INVENTION

In describing preferred embodiments of the present invention illustrated in the Figures, specific terminology is employed for the sake of clarity. The invention, however, is not intended to be limited to the specific terminology so selected, and it is to be understood that each specific element includes all technical equivalents that operate in a similar manner to accomplish a similar purpose. Particularly, for the purpose of convenience, the word “label” will be used exclusively henceforth, although it will be understood by those ordinarily skilled in the art that any of a variety of cards, labels, sheets, signs, or the like, may be retained within the label holder of the present invention for display thereof.

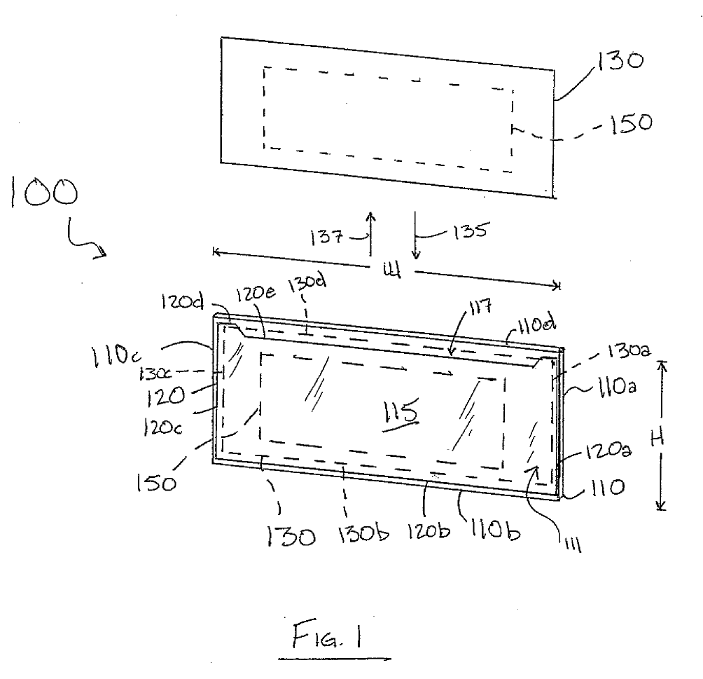

In that form of the preferred embodiment of the present invention chosen for purposes of illustration, FIG. 1 shows label holder 100, Preferably, label holder 100 comprises magnetic sheet 110 and transparent sheet 120. Magnetic sheet 110 preferably comprises a generally thin, rectangular, flexible body having a width W in a first direction, and a height H in a second direction. Preferably, width W of magnetic sheet 110 is substantially greater than height H of magnetic sheet 110, such that magnetic sheet 110 takes the form of a rectangle. Transparent sheet 120 is preferably likewise formed with a width and a height, the width and height of transparent sheet 120 being approximately equal to, and not greater than, width W and height H of magnetic sheet 110 at the conclusion of the forming process.

Transparent sheet 120 is preferably attached to front surface 111 of magnetic sheet 110 along right edges 110a and 120a, along bottom edges 110b and 120b, and along left edges 110c and 120c of magnetic sheet 110 and transparent sheet 120, respectively, thereby forming pocket 115 between magnetic sheet 110 and transparent sheet 120. Transparent sheet 120 may be permanently attached to magnetic sheet, such as by welding, adhering, or other suitable joining technique. Mouth 117 is preferably formed along top edges 110d and 120d by leaving top edges 110d and 120d mutually unattached. Transparent sheet 120 preferably further includes cutout section 120e along top edge 120d thereof. Cutout section 120e preferably exposes front surface 131 of label 130 near top edge 130d thereof when label 130 is disposed within pocket 115.

In use, card 130 may preferably be disposed within pocket 115 by insertion of card 130 into pocket 115 through mouth 117, such as by sliding card 130 in the direction of arrow 135. When card 130 is disposed within pocket 115, indicia 150 printed, or otherwise formed, thereon is preferably visible through transparent sheet 120 such that indicia 150 may be viewed by a user. Thus, label holder 100, when removably attached to a structure, such as a file cabinet drawer front, may preferably retain and display label 130 bearing indicia 150, such as information regarding the contents of the drawer. Should a user wish to change the information on the label, such as when indicia 150 no longer accurately indicates the contents of the drawer, the user needs merely to apply a removal force to label 130, such as by pushing on an exposed portion of front surface 131, proximate top edge 130d of label 130, in the direction of arrow 137.

As discussed above, pocket 115 is preferably formed by attachment of transparent sheet 120 to magnetic sheet 110. Preferably, such attachment is performed proximate peripheral portions of right side edge 120a, bottom edge 120b, and left side edge 120c, such that the internal dimensions of pocket 115 are substantially similar to the external dimensions of transparent sheet 120. Furthermore, a width of transparent sheet 120, defined as the distance between right side edge 120a and left side edge 120c, is selected to allow label 130 having a given width to fit within pocket 115. A height of transparent sheet 120, and thus of pocket 115, is preferably determined as a fraction of the width of transparent sheet 120. Preferably, the height of transparent sheet 120 is less than one half the width of transparent sheet 120, more preferably is less than one third of the width, and most preferably is less than one quarter of the length of transparent sheet 120. Such selection of the height of transparent sheet 120 relative to the width thereof preferably maintains a frictional force between label 130 and adjacent surfaces of magnetic sheet 110 and transparent sheet 120 below a predetermined maximum threshold such that a removal force required to remove label 130 from pocket 115 does not exceed a predetermined maximum desired level.

Furthermore, cutout section 120e is formed over a portion of top edge 120d having a predetermined width. The predetermined width of cutout portion 120e is preferably selected such that a sufficient amount of label 130 is exposed by cutout section 120e to allow a user to easily apply a removal force. As such, even if the width of label holder 100 is increased, the width of cutout portion 120e need not be increased. Conversely, the width of label holder 100 cannot be reduced beyond the width of cutout section 120e as a reduction in width of cutout section 120e will adversely impact an ability of a user to easily apply a removal force to label 130.

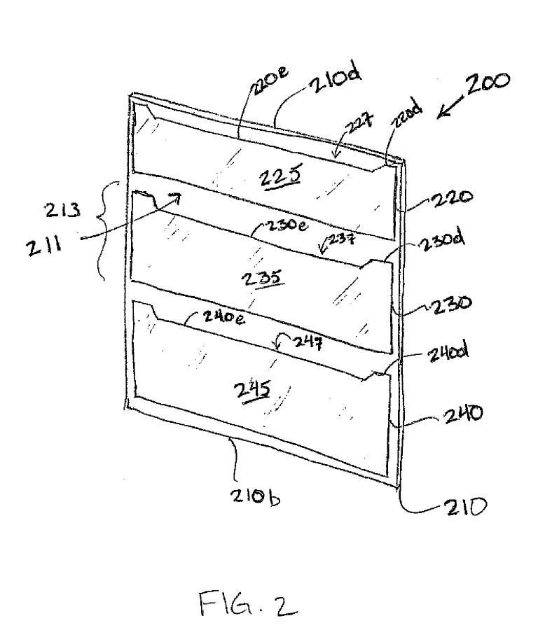

Now referring to FIG. 2, label holder 200 preferably comprises magnetic sheet 210, first transparent sheet 220, second transparent sheet 230, and third transparent sheet 240. First transparent sheet 220 is preferably attached to front surface 211 of magnetic sheet 210 proximate top edge 210d, thereby forming first pocket 225 therebetween. Pocket 225 is preferably accessible through mouth 227 defined by top edge 220d. Top edge 220d preferably includes cutout section 220e for exposing a front surface of a label, such as label 130, whereby a removal force may be applied to the label in order to remove the label from pocket 225 for alteration or replacement.

Second and third transparent sheets 230 and 240 are preferably likewise attached to front surface 211 of magnetic sheet 210 and in a similar manner to first transparent sheet 220, but proximate medial section 213 and bottom edge 210b, respectively. Second and third transparent sheets 230 and 240 preferably form pockets 235 and 245, respectively, when attached to magnetic sheet 210 and preferably include cutout sections 230e and 240e, respectively. Pockets 235 and 245 preferably include mouths 237 and 247, respectively defined by top edges 230d and 240d, respectively. Thus, one or more different label(s) may be inserted into selected ones of pockets 225, 235, and 245 for display therein. The alternative embodiment of FIG. 2 preferably enables additional information to be displayed on the structure via label holder 200 for a given width of label holder 200, without exceeding the maximum height of any of pockets 225, 235, and 245, as determined as described above with respect to pocket 115. While three pockets have been illustrated, it will be understood by one ordinarily skilled in the art that two, or four or more pockets may be disposed on magnetic sheet 210 without departing from the scope of the present invention. Furthermore, while pockets 225, 235, and 245 have been illustrated in a vertical arrangement, it will be understood by one skilled in the art that other arrangements may be utilized without departing from the scope of the present invention.

Although label holder 100, 200 has been described including magnetic sheet 110, 210 as means for removably attaching label holder 100, 200 to a structure, it will be understood by one skilled in the art that other means may alternatively be provided, such as a removable adhesive backed sheet, a hook and loop fastener, a static cling sheet, or other similar means, to allow label holder 110, 210 to be removably attached to a structure. Furthermore, while transparent sheet 120, 220 has been described as being approximately the same size as magnetic sheet 110, 210, it will be understood by one ordinarily skilled in the art that magnetic sheet 110, 210, or any of the alternative removable attachment means discussed above, may be larger than transparent sheet 120, 220, and that transparent sheet may not be completely transparent, such as by being merely translucent, without departing from the scope of the invention, so long as the indicia on the label may be seen and understood when the label is disposed in the pocket of the label holder.

In a method of manufacture of label holder 100, 200 of the present invention, a first step comprises determining a desired width of a pocket of the holder to receive a card or label. The method further comprises the steps of determining a maximum height dimension of the pocket that will allow for easy insertion and removal of the card or label, selecting a height less than or equal to the maximum height, and forming a holder having pocket with a width substantially equal to the determined width, and a height substantially equal to the selected height. These steps may be repeated to form multiple separate label holders, or to manufacture a label holder having a plurality of pockets. The method of manufacture preferably further includes the steps of determining a desired location of the pocket on a surface of the magnetic sheet.

Having, thus, described exemplary embodiments of the present invention, it should be noted by those ordinarily skilled in the art that the within disclosures are exemplary only and that various other alternatives, adaptations, and modifications may be made within the scope and spirit of the present invention. Accordingly, the present invention is not limited to the specific embodiments as illustrated herein, but is only limited by the following claims.

What is claimed is at least:

1. A label holding device comprising:
a first sheet;
attachment means for removably attaching said first sheet to a structure; and
at least one second sheet attached to said first sheet, thereby forming at least one pocket therebetween having a mouth;
wherein said at least one pocket comprises a width and a height, said mouth extending over substantially the entire width on a first edge of said at least one second sheet, and wherein said width is substantially greater than said height.

2. The label holding device of claim 1, wherein said at least one second sheet is substantially transparent.

3. The label holding device of claim 1, wherein said at least one second sheet comprises a cutout section proximate said at least one pocket.

4. The label holding device of claim 1, wherein a ratio of said width to said height is at least two to one.

5. The label holding device of claim 1, wherein a ratio of said width to said height is at least three to one.

6. The label holding device of claim 1, wherein a ratio of said width to said height is at least four to one.

7. The label holding device of claim 1, wherein said at least one pocket comprises a plurality of pockets.

8. The label holding device of claim 7, wherein each of said plurality of pockets comprises a cutout section proximate a mouth thereof.

9. The label holding device of claim 1, wherein said attachment means comprises a magnetic material.

10. A method of manufacturing a label holder comprising the steps of:
determining a desired width of at least one pocket of said label holder;
determining a maximum height of said at least one pocket based on said desired width;
selecting a desired height of said at least one pocket, said desired height being not greater than said maximum height; and
attaching a transparent sheet to a front surface of a sheet to form at least one pocket therebetween, said at least one pocket having a width approximately equal to said desired width and a height approximately equal to said desired height;
wherein said at least one pocket includes a mouth along a width side of said pocket, and wherein said sheet comprises removable attachment means for removable attachment to a structure.

11. The method of claim 10, further comprising the step of forming a cutout in said transparent sheet, wherein said step of attaching disposes said cutout proximate said mouth.

12. The method of claim 10, further comprising the step of attaching a second transparent sheet to said front surface of said sheet to form a second pocket.

13. The method of claim 10, wherein said step of attaching comprises forming a plurality of pockets.

14. The method of claim 13, wherein each of said plurality of pockets has a width approximately equal to said desired width and a height approximately equal to said desired height.
